(19) United States
(12) Patent Application Publication
(10) Pub. No.: US 2025/0125328 A1
(43) Pub. Date: Apr. 17, 2025

(54) METHOD FOR MANUFACTURING BATTERY

(71) Applicant: TOYOTA JIDOSHA KABUSHIKI KAISHA, Toyota-shi (JP)

(72) Inventors: Yosuke SHIMURA, Nagakute-shi (JP); Takahiko NAKANO, Nagoya-shi (JP); Hirokazu TAKEUCHI, Toyota-shi (JP); Masato NODA, Toyota-shi (JP); Atsushi SUGIHARA, Toyota-shi (JP); Jun IZUMI, Toyota-shi (JP); Yuka YOKOI, Nagoya-shi (JP)

(21) Appl. No.: 18/908,862

(22) Filed: Oct. 8, 2024

(30) Foreign Application Priority Data
Oct. 17, 2023 (JP) 2023-178919

(51) Int. Cl. H01M 4/04

(52) U.S. Cl. CPC H01M 4/0416; H01M 4/0471

(57) ABSTRACT

A method for manufacturing a battery, the method including: a first step of preparing an electrode body that includes an electrode containing an electrode active material and a solute of an electrolytic solution; and a second step of causing a solvent of the electrolytic solution to penetrate into the electrode body.

### CROSS-REFERENCE TO RELATED APPLICATION

This application is based on and claims priority under 35 USC 119 from Japanese Patent Application No. 2023-178919, filed on Oct. 17, 2023, the entire disclosure of which is incorporated by reference herein.

### BACKGROUND

### Technical Field

The present disclosure relates to a method for manufacturing a battery.

### Related Art

In a process for manufacturing a battery using an electrolytic solution obtained by dissolving an electrolyte in an organic solvent, a liquid injection operation is performed in which the electrolytic solution is supplied to an interior of an exterior body that accommodates an electrode body, and the electrolytic solution is caused to penetrate into the electrode body.

In some cases, processing is carried out in which an electrode of the battery is pressed at a high pressure to increase an energy density. When a packing density of an electrode active material within the electrode is increased by pressing the electrode, a penetrability of the electrolytic solution decreases. The decrease in the penetrability of the electrolytic solution causes a decrease in efficiency of the liquid injection operation.

Japanese Patent Application Laid-Open (JP-A) No. 2000-195549 describes a method for manufacturing a battery, which is characterized in that two types of electrolytic solutions having different compositions are dispensed. Specifically, by injecting the electrolytic solutions into a battery case in order from an electrolytic solution having a lower electrolyte concentration and a lower viscosity, a penetration speed of the electrolytic solution into the electrode body is increased.

In the method described in JP-A No. 2000-195549, since plural types of electrolytic solutions having different electrolyte concentrations are prepared and injection of these electrolytic solutions is carried out separated into plural times, there is room for improvement with respect to efficiency of a liquid injection operation.

### SUMMARY

In view of the foregoing, an object of one embodiment of the present disclosure is to provide a novel method for manufacturing a battery, in which efficiency of a liquid injection operation of an electrolytic solution is improved.

The means for solving the above-described problem include the following embodiments.

<1> A method for manufacturing a battery, the method including:
a first step of preparing an electrode body that includes an electrode containing an electrode active material and a solute of an electrolytic solution; and
a second step of causing a solvent of the electrolytic solution to penetrate into the electrode body.

<2> The method for manufacturing a battery according to <1>, wherein the solvent that is caused to penetrate into the electrode body in the second step does not contain the solute of the electrolytic solution.

<3> The method for manufacturing a battery according to <1> or <2>, wherein the second step includes depressurizing an interior of an exterior body that accommodates the electrode body.

<4> The method for manufacturing a battery according to any one of <1> to <3>, wherein the second step includes heating at least one of the electrode body or the solvent.

<5> The method for manufacturing a battery according to any one of <1> to <4>, wherein the second step includes applying ultrasonic vibration to the electrode body.

### BRIEF DESCRIPTION OF THE DRAWINGS

Embodiments of the present disclosure will be described in detail based on the following figures, wherein:

FIG. 1 is a diagram schematically illustrating an example of a configuration of a laminated body included in an electrode body;

FIG. 2 is a diagram schematically illustrating an example of application of a battery module to an electric vehicle;

FIG. 3 is a diagram schematically illustrating an example of a configuration of a battery module;

FIG. 4 is a diagram schematically illustrating an example of a configuration of a battery module; and

FIG. 5 is a diagram schematically illustrating an example of a configuration of a battery cell included in a battery module.

### DETAILED DESCRIPTION

In the present disclosure, a numerical range indicated by using “to” means a range in which numerical values described before and after “to” are included as a minimum value and a maximum value, respectively.

In numerical ranges described in the present disclosure in a stepwise manner, an upper limit value or a lower limit value described in a certain numerical range may be replaced with an upper limit value or a lower limit value of another numerical range described in a stepwise manner. In the numerical ranges described in the present disclosure, an upper limit value or a lower limit value described in a certain numerical range may be replaced with a value indicated in the examples.

In the present disclosure, the term “step” includes not only independent steps, and even in a case in which a step cannot be clearly distinguished from another step, it is encompassed by this term as long as the intended purpose of the step is achieved.

In a case in which an embodiment is explained in the present disclosure with reference to the drawings, the configuration of the embodiment is not limited to the configuration illustrated in the drawings. Furthermore, sizes of members in the respective drawings are conceptual, and relative relationships between sizes of members are not limited thereto.

The method for manufacturing a battery of the present disclosure includes:
a first step of preparing an electrode body that includes an electrode containing an electrode active material and a solute of an electrolytic solution; and
a second step of causing a solvent of the electrolytic solution to penetrate into the electrode body.

In a general method for manufacturing a battery, an electrolytic solution obtained by dissolving a solute such as a lithium salt in a solvent is supplied to an exterior body that accommodates an electrode body. Then, the operation is stopped and put on hold until the electrolytic solution that has been supplied to the exterior body penetrates into the electrode body. This on-hold time can cause a decrease in efficiency of the liquid injection operation.

In the method of the present disclosure, an electrode body that includes an electrode containing an electrode active material and a solute of an electrolytic solution is prepared first, and then a solvent of the electrolytic solution is caused to penetrate into the electrode body. Since a viscosity of the solvent that is caused to penetrate into the electrode body is lower than that in a case in which it contains the solute, the solvent penetrates into the electrode body in a shorter time than in a case in which it contains the solute. The solvent that has penetrated into the electrode body dissolves the solute that is contained in the electrode configuring the electrode body. In other words, the method of the present disclosure can bring about a state in which the electrolytic solution has penetrated into the electrode body in a shorter time than a conventional method.

Furthermore, in a case in which a size of the battery is large (for example, an area of a main surface exceeds 10,000 cm²), a flow behavior of the electrolytic solution when penetrating into the electrode body may not be uniform, and there is a possibility that deviation will be generated in a distribution of the solute after the liquid injection operation. In the method of the present disclosure, since the solute of the electrolytic solution can be disposed at any part of the electrode body before the solvent is caused to penetrate, it is possible to effectively suppress deviation in the distribution of the solute after the liquid injection operation.

### (First Step)

In the first step, the electrode body that includes the electrode containing the electrode active material and the solute of the electrolytic solution is prepared.

In the present disclosure, an electrode body refers to a structure that includes a laminated body composed of a positive electrode, a negative electrode, and a separator disposed between the positive electrode and the negative electrode.

Examples of a form of the electrode body including the laminated body composed of the positive electrode, the negative electrode, and the separator disposed between the positive electrode and the negative electrode include a state in which plural layers of laminated bodies that have been cut to predetermined dimensions are overlapped, a state in which an elongated laminated body is wound, and the like.

It is possible that all of the electrodes included in the electrode body contain the solute of the electrolytic solution, or it is possible that some of the electrodes included in the electrode body contain the solute of the electrolytic solution.

For example, in a case in which either one of the negative electrode or the positive electrode included in the electrode body contains the solute of the electrolytic solution, the other may or may not contain the solute of the electrolytic solution.

In general, a negative electrode has more voids between active material particles than a positive electrode, and is superior in penetrability of an electrolytic solution. For this reason, the negative electrode may contain the solute of the electrolytic solution.

A method for preparing the electrode containing the electrode active material and the solute of the electrolytic solution is not particularly limited. For example, a method of preparing the electrode using a composition containing the electrode active material and the solute of the electrolytic solution, a method of disposing the solute of the electrolytic solution on a surface of an electrode prepared using a composition containing the electrode active material, and the like may be used.

Types of the electrode active material and the solute of the electrolytic solution contained in the electrode are not particularly limited, and may be selected from commonly used substances.

Specific examples of the solute in a case in which the battery is a lithium-ion secondary battery include LiPF₆, LiFSi, and the like.

The solute contained in the electrode may be one kind alone, or may be two or more kinds thereof.

Specific examples of a positive electrode active material in a case in which the battery is a lithium-ion secondary battery include composite oxides formed of lithium and a transition metal, and optionally other metals (hereinafter, also referred to as lithium transition metal composite oxides). Examples of the transition metal and other metals include Ni, Co, Mn, Al, B, Mg, Ti, V, Cr, Fe, Cu, Zn, Ga, Sr, Zr, Nb, In, Sn, Ta, W, and the like.

Examples of the lithium transition metal composite oxide include layered lithium transition metal composite oxides, spinel-type lithium transition metal composite oxides, olivine-type lithium transition metal composite oxides, and the like.

Examples of the layered lithium transition metal composite oxide include those containing at least one selected from Ni, Co, or Mn as the transition metal. Specific examples thereof include compounds represented by a structural formula of LiNiₐCo_{b}Mn_{c}O₂ (in which each of a, b, and c is a number of 0 or more and 1 or less, and a+b+c=1), and compounds in which one or more elements selected from Al, Mg, La, Ti, Zn, B, W, Fe, Cr, V, Ru, Cu, Cd, Ag, Y, Sc, Ga, In, As, Sb, Pt, Au, Si, or the like are added to the aforementioned compounds.

Specific examples of the spinel-type lithium transition metal composite oxide include LiMn₂O₄.

Specific examples of the olivine-type lithium transition metal composite oxide include LiMPO₄ (in which M is Fe, Co, Ni or Mn).

The positive electrode active material contained in the electrode may be one kind alone, or may be two or more kinds thereof.

Specific examples of a negative electrode active material in a case in which the battery is a lithium-ion secondary battery include carbon materials such as graphite, hard carbon, soft carbon, activated carbon and the like, silicon, metallic lithium, lithium alloys, lithium titanate (LTO), and the like.

The negative electrode active material contained in the electrode may be one kind alone, or may be two or more kinds thereof.

The electrode may contain a conductive material.

Specific examples of the conductive material include carbon materials such as carbon black (acetylene black, thermal black, furnace black, or the like), carbon nanotubes, graphite, and the like.

The conductive material contained in the electrode may be one kind alone, or may be two or more kinds thereof.

The electrode may contain a binder.

Specific examples of the binder include polyvinylidene fluoride (PVdF), polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, polymethacrylate, polytetrafluoroethylene (PTFE), and the like.

The binder contained in the electrode may be one kind alone, or may be two or more kinds thereof.

The electrode included in the electrode body may include a current collector and an electrode layer disposed so as to contact one surface or both surfaces of the current collector.

A thickness of the electrode layer is not particularly limited, and may be selected from general thicknesses of electrode layers. For example, the thickness of the electrode layer may be selected from a range of from 10 μm to 200 μm.

Examples of a material configuring a current collector of the positive electrode include aluminum, aluminum alloys, nickel, titanium, stainless steel, and the like. Examples of a shape of the current collector include a foil, a mesh, and the like.

Examples of a material configuring a current collector of the negative electrode include copper, copper alloys, nickel, titanium, stainless steel, and the like. Examples of a shape of the current collector include a foil, a mesh, and the like.

Examples of the separator included in the electrode body include nonwoven fabrics, cloths, microporous films and the like, containing a polyolefin such as polyethylene, polypropylene or the like, as a main component.

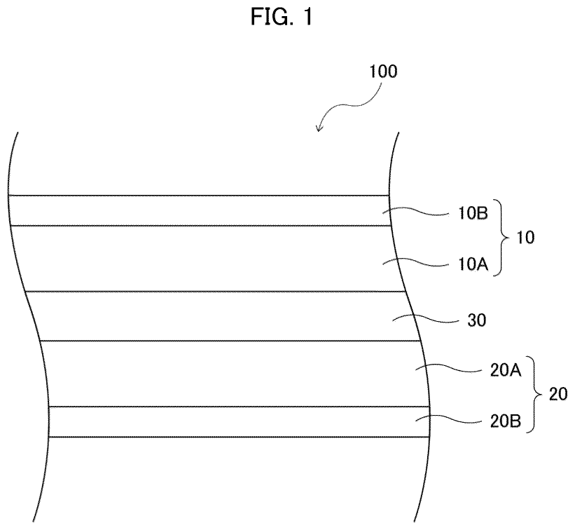

An example of a configuration of the laminated body included in the electrode body is schematically illustrated in FIG. 1.

A laminated body 100 illustrated in FIG. 1 includes a positive electrode 10, a negative electrode 20, and a separator 30 disposed between the positive electrode 10 and the negative electrode 20. The positive electrode 10 includes a positive electrode layer 10A and a positive electrode current collector 10B. The negative electrode 20 includes a negative electrode layer 20A and a negative electrode current collector 20B.

### (Second Step)

In the second step, the solvent of the electrolytic solution is caused to penetrate into the electrode body that has been prepared in the first step.

From the viewpoint of keeping the viscosity low, it is preferable that the solvent that is caused to penetrate into the electrode body does not contain the solute of the electrolytic solution.

The type of the solvent used in the second step is not particularly limited, and may be selected from solvents commonly used as components of electrolytic solutions.

Specific examples of the solvent include cyclic or linear carbonates such as ethylene carbonate (EC), dimethyl carbonate (DMC), diethyl carbonate (DEC), ethyl methyl carbonate (EMC) and the like. The solvent may be a mixture of two or more types of solvents, and may be a mixture containing a cyclic carbonate and a linear carbonate.

The solvent may contain an additive such as vinylene carbonate (VC) or the like.

In the second step, for example, the solvent is supplied to the interior of the exterior body that accommodates the electrode body to thereby cause the solvent to penetrate into the electrode body.

A method for supplying the solvent to the interior of the exterior body is not particularly limited, and may be selected from known methods.

A number of times that the solvent is supplied to the interior of the exterior body may be one time or plural times.

A total amount of the solvent that is supplied to the interior of the exterior body may be set so that a concentration of the solute, in a state in which the solute contained in the electrode body has been dissolved in the solvent, is within a range of from 1% by mass to 15% by mass.

The second step may include depressurizing the interior of the exterior body accommodating the electrode body. By depressurizing the interior of the exterior body accommodating the electrode body, penetration of the solvent into the electrode body can be promoted.

The second step may include heating at least one of the electrode body or the solvent. By heating at least one of the electrode body or the solvent, dissolution of the solute in the solvent within the electrode body can be promoted.

A temperature of the electrode body or the solvent in the heated state can be selected, for example, from a range of from room temperature to a boiling point of the solvent.

The second step may include applying ultrasonic vibration to the electrode body. By applying ultrasonic vibration to the electrode body, dissolution of the solute in the solvent within the electrode body can be promoted.

In a case in which ultrasonic vibration is applied to the electrode body, a frequency of the ultrasonic vibration is not particularly limited.

Ultrasonic vibrations having different frequencies may be applied to the electrode body separated into plural times. Alternatively, the ultrasonic vibration may be applied to different regions of the electrode body separated into plural times.

In certain embodiments, a step X of applying ultrasonic vibration X to a region X of the electrode body and a step Y of applying ultrasonic vibration Y to a region Y that is different from the region X of the electrode body may be performed in this order. In this regard, a frequency of the ultrasonic vibration X is smaller than a frequency of the ultrasonic vibration Y.

In step X, by applying the ultrasonic vibration X to the region X of the electrode body, bubbles contained in the region X of the electrode body are moved to the region Y.

When the solvent is caused to penetrate into the electrode body, bubbles may be generated in some cases. By moving the bubbles to the region Y without eliminating them, penetration of the solvent into the region X is promoted.

The frequency of the ultrasonic vibration X applied to the electrode body in step X is selected from frequencies that do not eliminate the bubbles (for example, 20 kHz to 100 kHz).

In step Y, by applying the ultrasonic vibration Y to the region Y that is different from the region X of the electrode body, the bubbles contained in the region Y of the electrode body are eliminated. By eliminating the bubbles contained in the region Y, penetration of the solvent into the region Y is promoted. Elimination of the bubbles may be performed by dissolving gas in the bubbles in the solvent.

The frequency of the ultrasonic vibration Y applied to the electrode body in step Y is selected from frequencies that eliminate the bubbles (for example, greater than 100 kHz).

The type of the exterior body in which the electrode body is accommodated is not particularly limited, and may be selected according to the type of the battery.

In certain embodiments, a sheet-shaped exterior body may be used.

Examples of the sheet-shaped exterior body include those containing a metal. Specific examples include laminated bodies (so-called laminate films) having a metal layer containing a metal such as aluminum or the like, and a heat seal layer containing a resin that is melted by heating. That is to say, the battery manufactured by the method of the present disclosure may be a battery (so-called laminate battery) in which a laminate film is used as the exterior body.

The exterior body may be a single member, or may be composed of two or more members. For example, in a case in which the exterior body is a sheet-shaped object, the exterior body may be composed of one sheet-shaped object, or may be composed of two sheets-shaped objects.

If necessary, a recess for accommodating the electrode body may be formed at the sheet-shaped exterior body by embossing.

Examples of a method for accommodating the electrode body in the exterior body using a sheet-shaped exterior body include, for example, the following Method 1 and Method 2.

Method 1: a method of, in a state in which the electrode body is disposed between one exterior body that has been folded in half or between two exterior bodies that have been superposed, joining the exterior body (or bodies) at a periphery of the electrode body

Method 2: a method of inserting the electrode body into a bag that has been prepared by joining a periphery of one exterior body that has been folded in half or two exterior bodies that have been superposed

### Types of the Battery and Application Examples

The type of the battery manufactured by the method of the present disclosure is not particularly limited.

Specific examples of the battery include secondary batteries such as lithium-ion secondary batteries, lead storage batteries, nickel-hydrogen storage batteries, nickel-cadmium storage batteries, nickel-iron storage batteries, nickel-zinc storage batteries, silver oxide-zinc storage batteries, cobalt titanium lithium secondary batteries, and the like.

From the viewpoints of energy density, versatility, and the like, the battery may be a lithium-ion secondary battery.

The battery of the present disclosure may be mounted at an electric vehicle. An example in which the battery of the present disclosure is applied to an electric vehicle will be explained below with reference to the drawings. In the following explanation, a “battery cell 20” corresponds to the battery of the present disclosure.

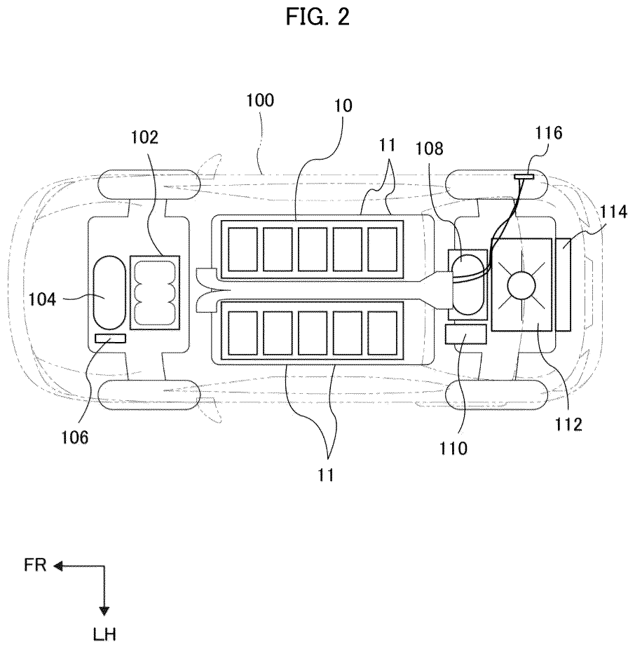

FIG. 2 is a schematic plan view illustrating a main part of a vehicle 100 to which a battery pack 10 according to an embodiment has been applied. As shown in FIG. 2, the vehicle 100 is an electric vehicle (battery electric vehicle (BEV)) at which the battery pack 10 is mounted under a floor. It should be noted that arrow UP, arrow FR, and arrow LH in the respective drawings respectively indicate an upper side in a vehicle up-down direction, a front side in a vehicle front-rear direction, and a left side in a vehicle width direction. In cases in which explanation is given using front-rear, left-right, and up-down directions, unless otherwise specified, these indicate front and rear in the vehicle front-rear direction, left and right in the vehicle width direction, and up and down in the vehicle up-down direction.

As an example, in the vehicle 100 of the present embodiment, a DC/DC converter 102, an electric compressor 104, and a positive temperature coefficient (PTC) heater 106 are arranged further toward a vehicle front side than the battery pack 10. Further, a motor 108, a gear box 110, an inverter 112, and a charger 114 are arranged further toward a vehicle rear side than the battery pack 10.

A DC current that has been output from the battery pack 10 is adjusted in voltage by the DC/DC converter 102, and thereafter supplied to the electric compressor 104, the PTC heater 106, the inverter 112, and the like. Furthermore, due to electric power being supplied to the motor 108 via the inverter 112, rear wheels rotate to drive the vehicle 100.

A charging port 116 is provided at a right side portion of a rear portion of the vehicle 100. By connecting a charging plug of an external charging facility, which is not illustrated in the drawings, from the charging port 116, electric power can be stored in the battery pack 10 via the charger 114.

An arrangement, structure and the like of the respective components configuring the vehicle 100 are not limited to the configuration described above. For example, the present disclosure may be applied to vehicles installed with an engine such as hybrid vehicles (HV) and plug-in hybrid electric vehicles (PHEV). Further, in the present embodiment, although the vehicle is configured as a rear-wheel drive vehicle in which the motor 108 is mounted at the rear portion of the vehicle, there is no limitation thereto; the vehicle may be configured as a front-wheel drive vehicle in which the motor 108 is mounted at the front portion of the vehicle, and a pair of motors 108 may also be mounted at the front and rear of the vehicle. Furthermore, the vehicle may also be provided with in-wheel motors at the respective wheels.

The battery pack 10 is configured to include plural battery modules 11. In the present embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Furthermore, each of the battery modules 11 are electrically connected to each other.

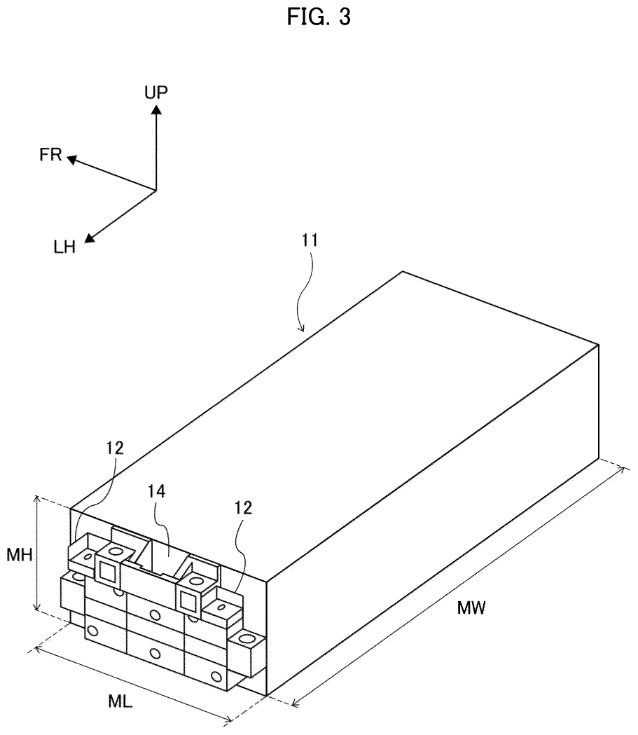

FIG. 3 is a schematic perspective view of a battery module 11. As shown in FIG. 3, the battery module 11 is formed in a substantially rectangular parallelepiped shape having a longitudinal direction along the vehicle width direction. Furthermore, an outer shell of the battery module 11 is formed of an aluminum alloy. For example, the outer shell of the battery module 11 is formed by joining aluminum die-casting to both ends of an extruded material of an aluminum alloy by laser welding or the like.

A pair of voltage terminals 12 and a connector 14 are provided at both vehicle width direction end portions of the battery module 11. A flexible printed circuit board 21, which will be described later, is connected to the connector 14. Furthermore, bus bars, which are not illustrated in the drawings, are welded to both vehicle width direction end portions of the battery module 11.

A length MW of the battery module 11 in the vehicle width direction is, for example, from 350 mm to 600 mm; a length ML thereof in the vehicle front-rear direction is, for example, from 150 mm to 250 mm; and a height MH thereof in the vehicle up-down direction is, for example, from 80 mm to 110 mm.

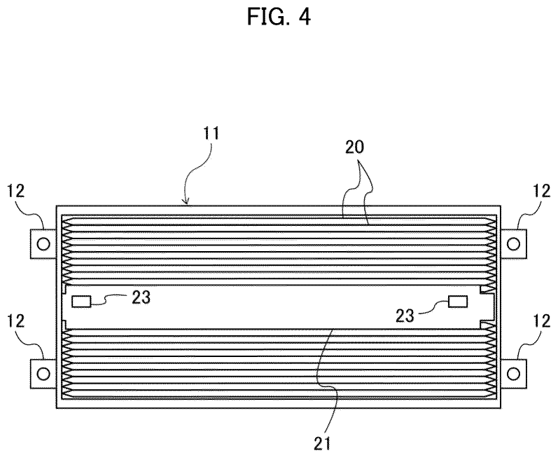

FIG. 4 is a plan view of the battery module 11 in a state in which an upper lid thereof has been removed. As shown in FIG. 4, plural battery cells 20 are accommodated at an interior of the battery module 11 in an arranged state. In the present embodiment, as an example, twenty-four battery cells 20 are arranged in the vehicle front-rear direction and are adhered to each other.

A flexible printed circuit (FPC) board 21 is disposed on the battery cells 20. The flexible printed circuit board 21 is formed in a band shape with a longitudinal direction thereof along the vehicle width direction, and thermistors 23 are respectively provided at both end portions of the flexible printed circuit board 21. The thermistors 23 are not adhered to the battery cells 20 and are configured to be pressed toward the battery cells 20 side by the upper lid of the battery module 11.

Furthermore, one or more cushioning materials, which are not illustrated in the drawings, are accommodated at the interior of the battery module 11. For example, the cushioning material is a thin plate-shaped member that is elastically deformable, and is disposed between adjacent battery cells 20 with a thickness direction thereof along an arrangement direction of the battery cells 20. In the present embodiment, as an example, cushioning materials are respectively arranged at both end portions in the longitudinal direction of the battery module 11 and at the center portion in the longitudinal direction of the battery module 11, respectively.

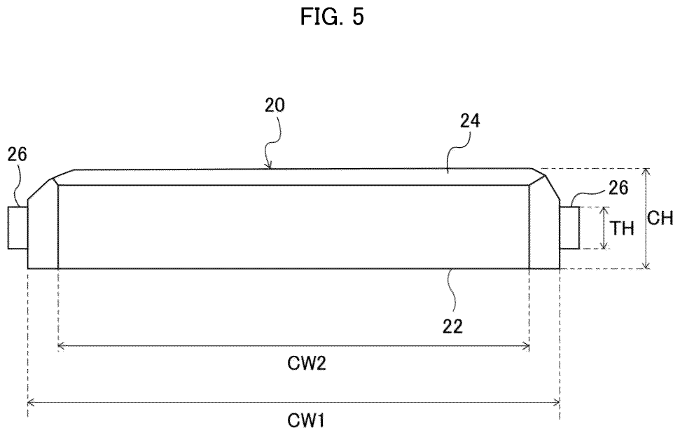

FIG. 5 is a schematic diagram in which a battery cell 20 that is accommodated in the battery module 11 is viewed from a thickness direction thereof. As shown in FIG. 5, the battery cell 20 is formed in a substantially rectangular plate shape, and an electrode body, which is not shown in the drawings, is accommodated at an interior thereof. The electrode body is configured by laminating a positive electrode, a negative electrode, and a separator, and is sealed by a laminate film 22.

In the present embodiment, as an example, the embossed, sheet-shaped laminate film 22 is folded and bonded to thereby form a housing portion of the electrode body. The laminate film 22 may have either a single-cup embossing structure in which embossing is at one place or a double-cup embossing structure in which embossing is at two places. In an embodiment, the laminate film 22 has a single-cup embossing structure with a draw depth of from about 8 mm to 10 mm.

Upper ends of both longitudinal direction end portions of the battery cell 20 are folded over, and corners thereof form an outer shape. Furthermore, an upper end portion of the battery cell 20 is folded over, and a fixing tape 24 is wound around the upper end portion of the battery cell 20 along the longitudinal direction.

Terminals (tabs) 26 are respectively provided at both ends in the longitudinal direction of the battery cell 20. In the present embodiment, as an example, the terminals 26 are provided at positions that are offset downward from the center of the battery cell 20 in the up-down direction. The terminals 26 are connected to the bus bars, which are not illustrated in the drawings, by laser welding or the like.

For example, the battery cell 20 has a length CW1 in the vehicle width direction of from 530 mm to 600 mm, from 600 mm to 700 mm, from 700 mm to 800 mm, from 800 mm to 900 mm, or greater than or equal to 1000 mm; a length CW2 of the region in which the electrode body is housed of from 500 mm to 520 mm, from 600 mm to 700 mm, from 700 mm to 800 mm, from 800 to 900 mm, or greater than or equal to 1000 mm; a height CH of from 80 mm to 110 mm or from 110 mm to 140 mm; a thickness of from 5.0 mm to 7.0 mm, from 7.0 mm to 9.0 mm, or from 9.0 mm to 11.0 mm; and a height TH of the terminal 26 of from 40 mm to 50 mm, from 50 mm to 60 mm, or from 60 mm to 70 mm.

All publications, patent applications, and technical standards mentioned in the present specification are incorporated herein by reference to the same extent as if each individual publication, patent application, or technical standard was specifically and individually indicated to be incorporated by reference.

What is claimed is:

1. A method for manufacturing a battery, the method comprising:
a first step of preparing an electrode body that includes an electrode containing an electrode active material and a solute of an electrolytic solution; and
a second step of causing a solvent of the electrolytic solution to penetrate into the electrode body.

2. The method for manufacturing a battery according to claim 1, wherein the solvent that is caused to penetrate into the electrode body in the second step does not contain the solute of the electrolytic solution.

3. The method for manufacturing a battery according to claim 1, wherein the second step includes depressurizing an interior of an exterior body that accommodates the electrode body.

4. The method for manufacturing a battery according to claim 1, wherein the second step includes heating at least one of the electrode body or the solvent.

5. The method for manufacturing a battery according to claim 1, wherein the second step includes applying ultrasonic vibration to the electrode body.
